(19) United States
(12) Patent Application Publication
(10) Pub. No.: US 2026/0061582 A1
(43) Pub. Date: Mar. 5, 2026

(54) Spot Tool Set

(71) Applicant: Jamonn Roberts, Pamona, CA (US)

(72) Inventor: Jamonn Roberts, Pamona, CA (US)

(21) Appl. No.: 19/313,864

(22) Filed: Aug. 29, 2025

Related U.S. Application Data
(60) Provisional application No. 63/688,627, filed on Aug. 29, 2024.

(51) Int. Cl. B25F 1/02; A46B 5/00; A46B 5/02; B24D 15/04; B25G 1/04; B25G 1/06; B25G 3/28

(52) U.S. Cl. CPC B25F 1/02; A46B 5/0095; A46B 5/02; B24D 15/04; B25G 1/04; B25G 1/06; B25G 3/28; A46B 2200/302

(57) ABSTRACT

Representative embodiments of devices and techniques disclose improved tools and tool sets for simplifying and improving the process of preparing or fixing skateboard obstacles to make the obstacles more skateable. For instance, the devices and techniques can be used for smoothing and preparing the surfaces of concrete (and other material) surfaces and edges to improve them for use with a skateboard. The tools can include a brick tool, a broom tool, and an adjustable handle, and a tool set can include at least one of each.

### PRIORITY CLAIM AND CROSS-REFERENCE TO RELATED APPLICATION

This application claims the benefit under 35 U.S.C. § 119(e)(1) of U.S. Provisional Application No. 63/688,627, filed Aug. 29, 2024, which is hereby incorporated by reference in its entirety.

### BACKGROUND

Skateboarding as recreation, sport, or competition can include riding a skateboard on various objects as an alternative to or in addition to skating on relatively planar sidewalks, streets, paths, and so forth. For instance, some skateboarders use urban environment features such as curbs, benches, and ledges to perform tricks on these features. Stonework, sculptures, walls, steps, and other features are also used to boardslide, grind, and otherwise do tricks and traverse using a skateboard.

Many cities and neighborhoods have also built dedicated skate parks that include concrete structures and features such as ledges, bowls, ramps, walls, rails, and so forth. While the use of these features with a skateboard can have a tendency to wear or smooth the surfaces and edges of the features, intentionally smoothing the features can improve the quality of the tricks performed and the duration of maneuvers such as slides and grinds.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes, designs, and/or dimensions shown in the illustrations of the figures are for example, and other shapes, designs, and/or dimensions may be used and remain within the scope of the disclosure, unless specified otherwise.

FIG. 1A shows an example of a user smoothing a surface with a hand tool.

FIG. 1B shows an example hand brush for brushing the surface.

FIGS. 2A, 2B, and 2C show example components of a spot tool set, according to an embodiment.

FIGS. 3A, 3B, and 3C show views of an example brick tool and receiver, according to an embodiment.

FIGS. 4A and 4B show views of an example brick tool and receiver, according to another embodiment.

FIG. 5A shows an example broom tool and receiver, according to an embodiment.

FIG. 5B shows an example broom tool and FIG. 5C shows an example receiver, according to an embodiment.

FIG. 6A shows an example adjustable handle, according to an embodiment.

FIGS. 6B and 6C show details of example adjustable handles, according to embodiments.

FIG. 7 shows a view of an example adjustable handle being attached to an example brick tool, according to an embodiment.

FIGS. 8A-8C show views of an example adjustable handle, according to an embodiment.

FIGS. 9A-9C show example additional components of a spot tool set, according to an embodiment.

FIGS. 10A-10C show example additional tools, which can also be included in a spot tool set, according to an embodiment.

### DETAILED DESCRIPTION

### Overview

Many cities and neighborhoods have dedicated skate parks and other areas that include concrete structures and features such as ledges, bowls, ramps, walls, rails, and so forth, used by skateboarders. While the use of these features with a skateboard can tend to wear or smooth the surfaces and edges of the features, intentionally smoothing the features can improve the quality of the tricks performed and the duration of maneuvers such as slides and grinds.

In some cases, wax or similar materials can also be applied to the surfaces and edges of the features to improve the quality of the features for skateboarding. For instance, working wax or other materials into the concrete (for example) of the features, along with removing high spots and filling low spots in the edges and surfaces of the features can cause the surfaces and edges of the features to be much smoother, enhancing the quality of the features for performing skateboarding tricks.

### Example Embodiments

Representative embodiments of devices and techniques disclose improved tools and tool sets for simplifying and improving the process of preparing or fixing skateboard obstacles to make the obstacles more skateable. For instance, the devices and techniques can be used for smoothing and preparing the surfaces of concrete (and other material) surfaces and edges to improve them for use with a skateboard.

The improved tools can be used with handles to allow the user to have a greater reach with the tools and to have a more upright posture when using them. The improved tools can also provide better angles of use, more effective results, and added convenience, including versatility and modularity. For instance, in some cases, the improved tools can be used interchangeably on provided handles that have length adjustments.

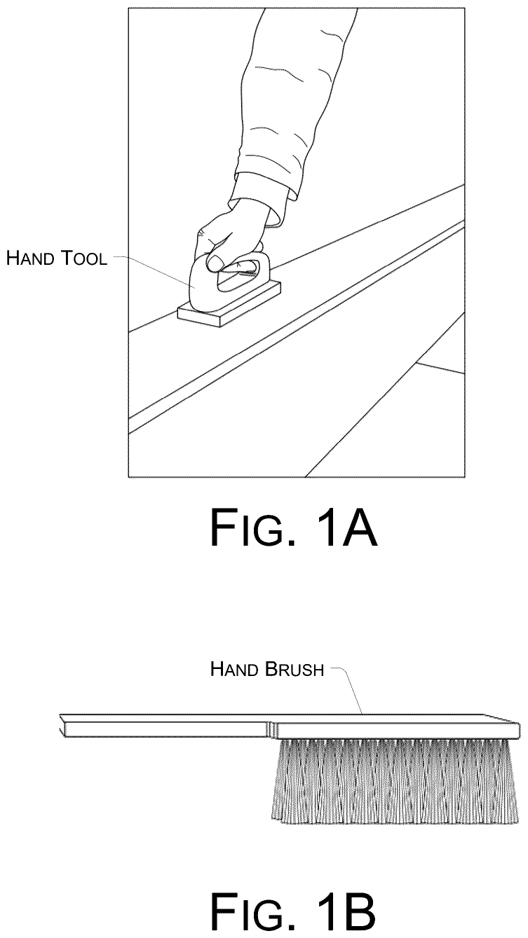

FIG. 1A shows a drawing of a skateboarder using a hand tool to smooth the top surface and edges of a short concrete wall. Smoothing the wall can include rubbing an abrasive surface across the surfaces and edges of the wall as well as applying wax (for example) to the surfaces and edges of the wall, working the wax into the concrete, and smoothing the waxed surface to create a uniform riding surface.

The smoothing action tends to remove material from the wall, leaving particles, dust, and other debris as a result. FIG. 1B shows a hand broom that the skateboarder can use to remove the debris from the wall, leaving the wall clean and smooth for skateboarding use. However, with hand tools, the user may not be in an optimal posture during either process. With the hand tools, the user is bent over the work area, sometimes for extended time periods. A less-than-optimal posture can lead to back problems or other health problems over time. Further, the less-than-optimal posture can also be less effective in each step of the process, requiring greater effort, time, and work.

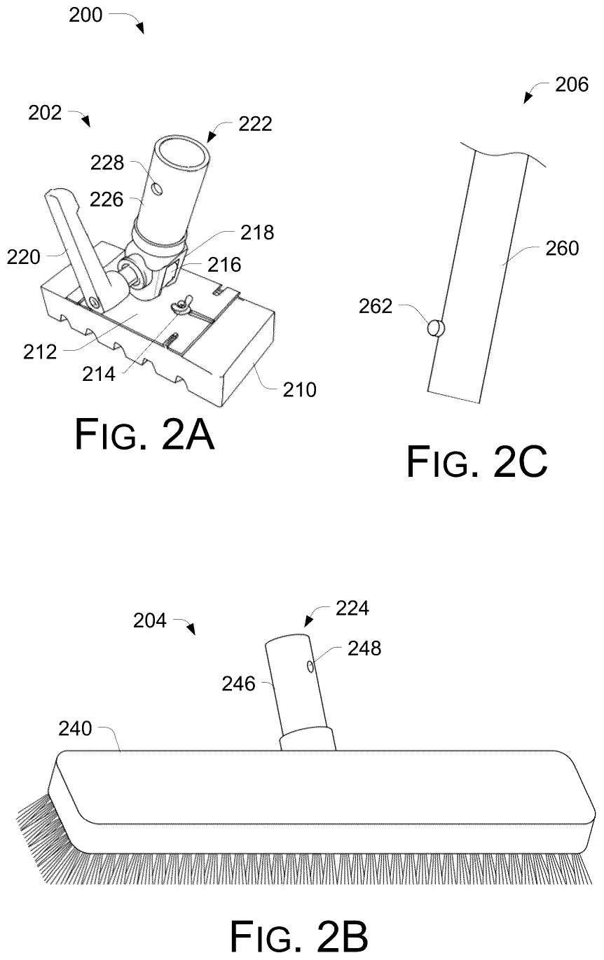

FIGS. 2A-2C illustrate examples of improved spot tools 202, 204, and 206 and an improved spot tool set 200. The spot tools 202, 204, and 206 or the spot tool set 200 allow the user to have a longer reach when preparing the wall (or other structure) for skateboard use and to have a more upright posture during the process. The improved tools 202, 204, and 206 and tool set 200 can provide better use angles for more effective results, and add the convenience and versatility of modularity, with handles 206 that have length adjustments that can be used with interchangeable tools (e.g., 202 and 204).

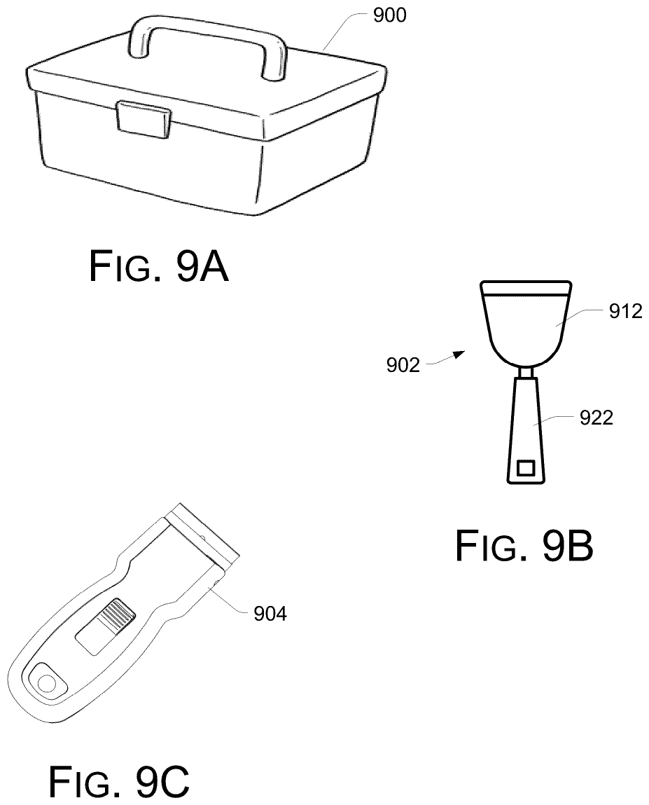

For example, the spot tool set 200 (“set 200”) comprises a tool system that can include an abrasive stone tool (“brick tool 202”), a brush or broom tool (“broom tool 204”) and an adjustable handle tool (“handle 206”). The brick tool 202 can comprise an abrasive stone 210 mounted to a quick release receiver 222. The broom tool 204 can comprise a brush 240 mounted to a similar quick release receiver 224. The handle 206 can be adjustable in length and can include features to be used with either the brick tool 202 or the broom tool 204 or other similarly prepared tools. For example, the handle 206 can be used with either the brick receiver 222 or the broom receiver 224 (or other like receivers coupled to various other tools). The features of the handle 206, along with the receivers (e.g., 222 and 224) allow the various tools, such as the brick tool 202 and the broom tool 204 to be interchangeably used with the handle 206. Alternate sets 200 may also include additional components that may or may not be capable of attachment to the handle 206 (see FIG. 9D, for example).

Benefits of the improved tools 202, 204, and 206 and of the tool set 200 can include the ease and convenience of storing and carrying the desired tools (particularly when a carrying case or the like is provided with the set 200). Many of the improved tools such as the brick tool 202 and the broom tool 204 include a quick release receiver (e.g., 222 and 224) for fast and efficient tool use and interchangeability with the handle 206. More efficient tools results in improved production time-meaning less time preparing and more time skateboarding.

The upright standing position for performing the preparation operations minimizes fatigue and dust exposure to the user. This can result in immediate and long-term health benefits for the user. Interchangeable tools 202 and 204 allow a single handle 206 to be used with each. However, additional handles 206 can be included in a set 200, so that more than one tool can have a handle 206 attached, allowing more than one user can be productive at a time. Other benefits of the tools 202, 204, and 206 and the set 200 will be apparent to persons skilled in the art.

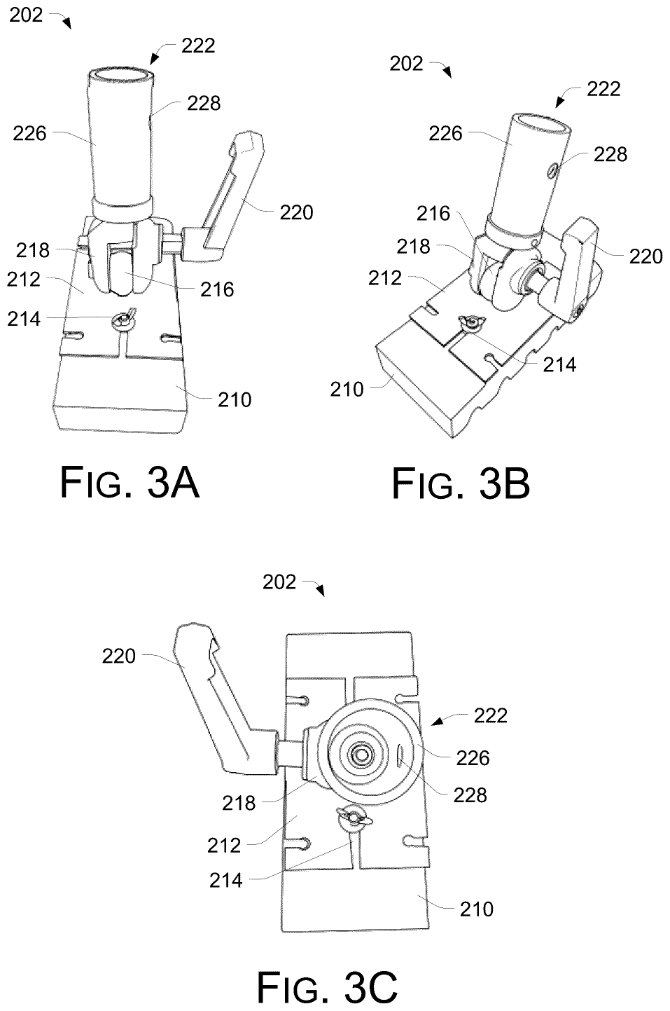

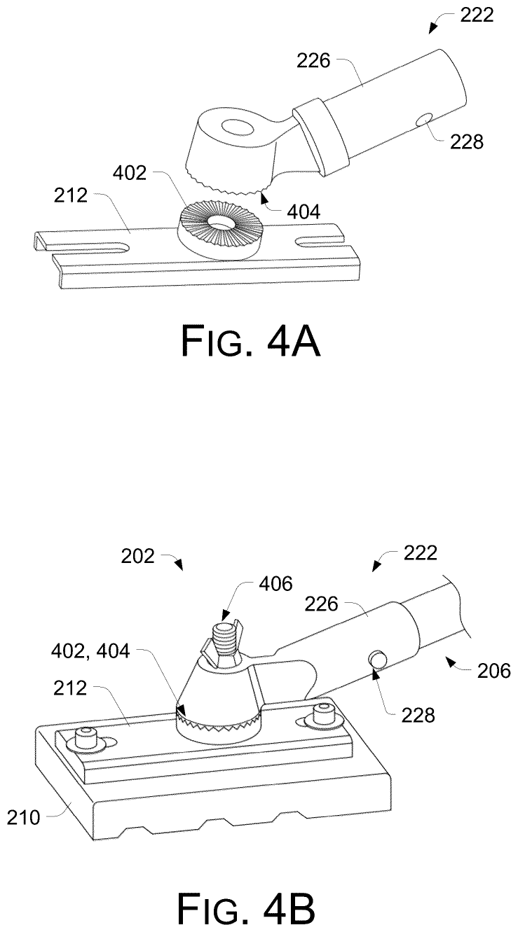

FIG. 2A shows an example brick tool 202. Example brick tools 202 are also shown at FIGS. 3A-3C and 4B. In various examples, an abrasive stone 210 (or like natural or synthetic material) is coupled to a receiver 222 for attachment to the handle 206. The stone 210 has a rough texture for smoothing concrete and other materials and is durable to withstand multiple uses. The stone 210 can be mounted to the receiver 222 via a brick mount 212 as shown. The brick mount 212 comprises a bracket or a like component that can be coupled to the stone 210. For example, the brick mount 212 can include holes or slots 214 for mounting the brick mount 212 to the stone 210, with removable fasteners, for instance. The brick mount 212 also includes mount components for coupling the receiver 222 to the brick mount 212.

In one example, as shown at FIGS. 3A-3C, the mount component comprises a ball mount 216. The ball mount 216 can be fixed to the brick mount 212. In the example, the receiver jaws 218 of the receiver 222 can clamp over the ball mount 216, securing the receiver 222 to the brick mount 212. A jaw tensioner 220 is used to tighten the receiver jaws 218 onto the ball mount 216 at the desired position and angle. For example, the jaw tensioner 220 can be threaded into at least one of the receiver jaws 218, to tighten or loosen the receiver jaws 218 on the ball mount 216. This arrangement allows for infinite adjustment of the position and angle of the receiver 222 (and thus the handle 206) on the brick mount 212. The handle 206 is inserted into the barrel 226 of the receiver 222.

Referring to FIGS. 4A and 4B, another example embodiment is given. As before, the brick mount 212 is removably coupled to the stone 210. In the embodiment, the brick mount 212 includes first angle adjustment teeth 402 and the receiver 222 includes second angle adjustment teeth 404, which can be aligned by the user to set an angle of the receiver 222 with respect to the brick mount 212 when they are mated together. The receiver 222 can be rotated to the desired angle when coupling the receiver 222 to the brick mount 212, so that the corresponding teeth (402 and 404) mesh together. A fastener set 406, such as a bolt and a wing nut as shown (or other fasteners) can be used to tighten the receiver 222 to the brick mount 212 at the desired angle. With the receiver 222 in place, as shown at FIG. 4B, the brick tool 202 can be coupled to the handle 206 as described above, and removed for interchanging with a broom tool 204, or another tool as described.

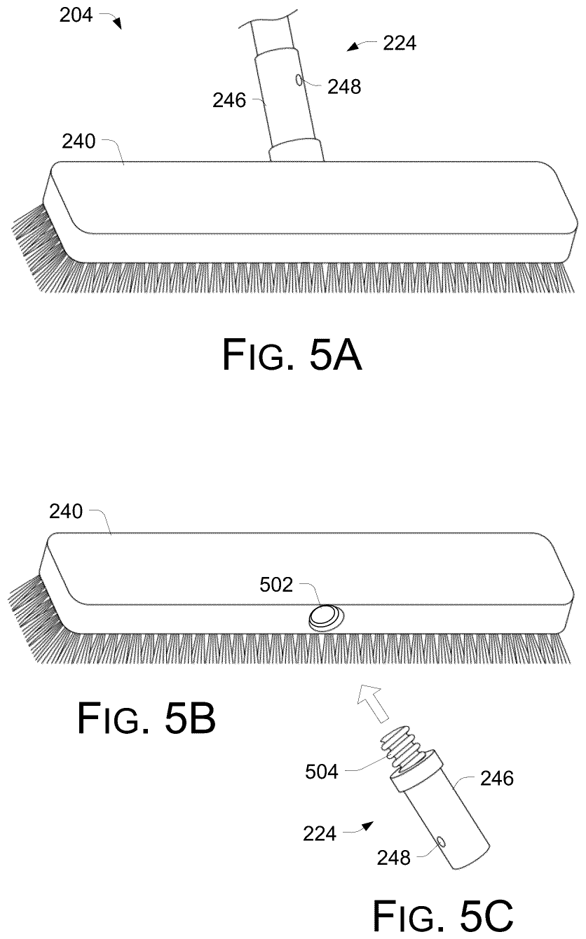

FIG. 2B shows an example broom tool 204. Example broom tools 204 are also shown at FIGS. 5A, and FIG. 5B with FIG. 5C. In various examples, a brush 240 (or a like component) is coupled to a receiver 224 for attachment to the handle 206. The brush portion 240 of the broom tool 204 can be any length or width desired.

The brush 240 can include a threaded hole 502 for the receiver 224 to be coupled to the brush 240. For example, the receiver 224 can be coupled to the brush 240 by threading the threaded end 504 of the receiver 224 into the threaded hole 502 of the brush 240. Brushes 240 of different sizes and shapes can be easily and quickly exchanged by coupling a receiver 224 to the desired brush 240. In alternate embodiments, the receiver 224 can be coupled to the brush 240 by other techniques (e.g., press-fit, turn-and-lock, fasteners, etc.).

With the receiver 224 in place on the brush 240, the brush 240 can be coupled to the handle 206. The handle 206 is inserted into the barrel 246 of the receiver 224, and can be removed for interchanging with a brick tool 202 or another tool as described.

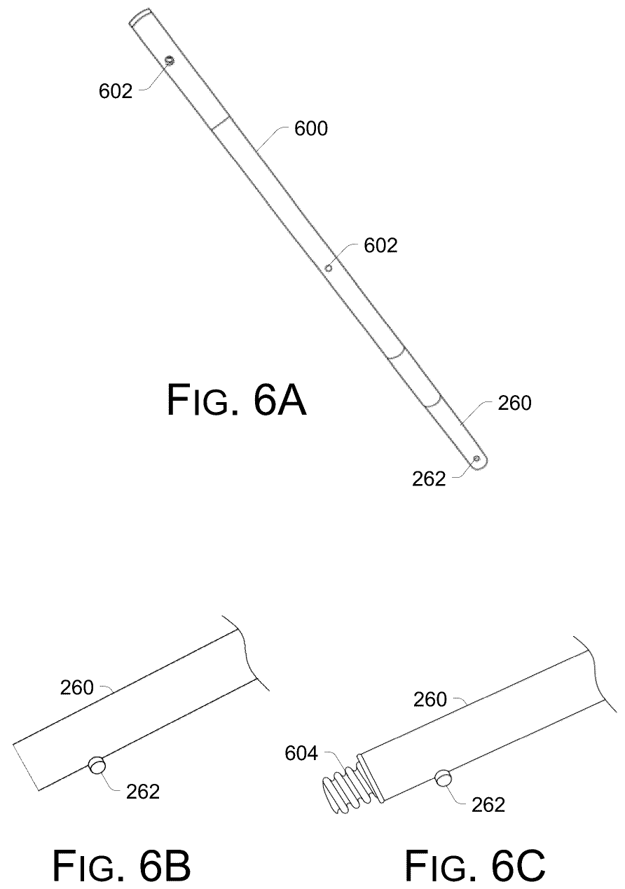

An example adjustable handle 206 is shown at FIG. 6A. An adjustable handle 206 includes a handle body 600, which may include one or more separate pieces, and an insertion end 260. The separate pieces of the handle body 600 can be joined together temporarily or permanently (e.g., for length adjustment). The insertion end 260 of the handle 206 is arranged to be inserted into a receiver (e.g., 222 and 224). Alternate insertion ends 260 of example adjustable handles 206 are shown at FIGS. 6B and 6C.

As shown at FIG. 6B, the insertion end 260 of the handle 206 can be smooth and include a quick release button 262. Alternatively, as shown at FIG. 6C, the insertion end 260 of the handle 206 can include features such as a threaded twist coupling 604 as well as a quick release button 262. In other embodiments, the insertion end 260 of the handle 206 can include other types of couplers for coupling the handle 206 to the receivers (e.g., 222 and 224).

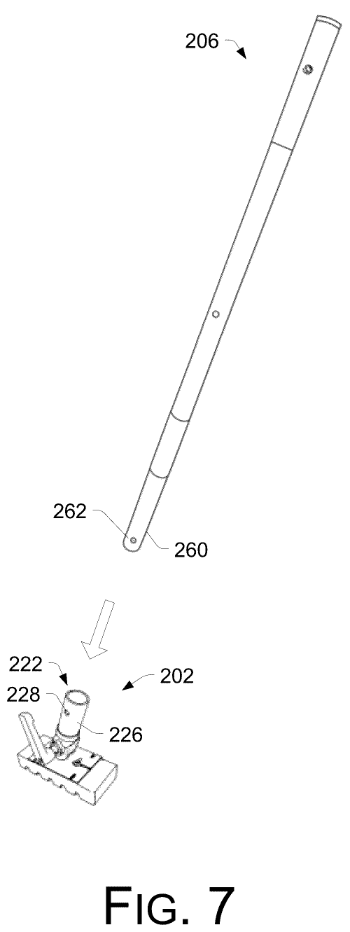

Referring to FIGS. 2A-2C and FIG. 7, techniques for coupling the tools (202 and 204) to the handle 206 can include multiple coupling components. For instance, as shown and described herein, the brick tool 202 and the broom tool 204 each includes a receiver (222 and 224, respectively) configured to receive the adjustable handle 206. Other tools in the set 200 may also include a quick release receiver similar to the receiver 222 or the receiver 224 (see FIG. 9D, for example).

Each receiver (e.g., 222 and 224) includes a barrel (e.g., 226 and 246, respectively). The barrel (226, 246) includes one or more features that provide a quick coupling and release of the receiver (222, 224) to the handle 206. For example, each barrel (226, 246) includes a quick release hole (228, 248, respectively), and the handle 206 includes a corresponding quick release button 262 (or vice versa). Inserting the handle 206 into the barrel (226, 246) engages the biased (e.g., spring-loaded, etc.) quick release button 262 into the quick release hole (228, 248) of the respective barrel (226, 246), which couples the handle 206 to the receiver (222, 224).

Removing the tools (202 and 204) from the handle 206 is also fast and easy. The quick release button 262 on the handle 206 can be depressed to release the handle 206 from the receiver (222, 224). The handle 206 can be removed from the receiver (222, 224) by pulling the handle 206 back out of the barrel (226, 246).

In alternate examples, additional or alternative coupling techniques can also be used. For example, the interior surface of the barrel (226, 246) can include additional features that are arranged to engage with the insertion end 260 of the handle 206. In one example, the interior surface of the barrel (226, 246) is threaded, and the insertion end 260 of the handle 206 includes a corresponding threaded portion 604. In the example, coupling the handle 206 to the receiver (222, 224) includes twisting the insertion end 260 of the handle 206 into the barrel (226, 246) of the respective tool (202, 204). Once the insertion end 260 is fully in the barrel (226, 246), the biased quick release button 262 on the handle 206 protrudes into the quick release hole (228, 248) of the respective barrel (226, 246). Releasing the handle 206 from the tool (202, 204) comprises reversing the steps: depressing the quick release button 262 and twisting the handle 206 in the opposite direction.

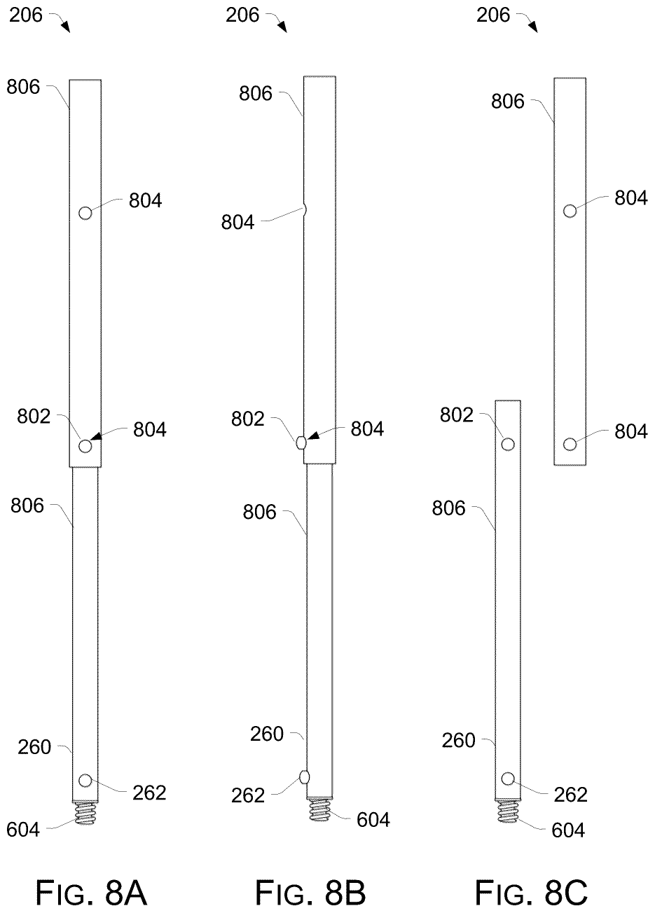

As shown at FIGS. 8A-8C, the adjustable handle 206 can also use quick release buttons 802 and holes 804 to add a handle extension 806 to the handle 206, to lengthen the handle 206. For instance, with the handle 206 comprising two or more shorter interconnecting segments 806, the handle 206 can be more easily stored in a carrying case (such as the carrying case 900 shown at FIG. 9A). However, one segment 806 of the handle 206 can be used alone with the tools (202, 204) by coupling the handle 206 to the receiver (222, 224) of the desired tool (202, 204) as described above.

To lengthen the handle 206, a handle extension 806 (or other extension) can be inserted into the back end of the handle 206, engaging the quick release button 802 of one segment 806 to the quick release hole 804 of the other segment 806. Additional extensions 806 can also be added in a like manner to the handle 206. In alternate embodiments, the handle 206 can comprise a telescopic tube, or other extendable tube, to provide adjustable lengths to the handle 206. The handle 206 and handle segments/extensions 806 can comprise tubes or pipes made of metal, composite, fiberglass, polymers, or the like.

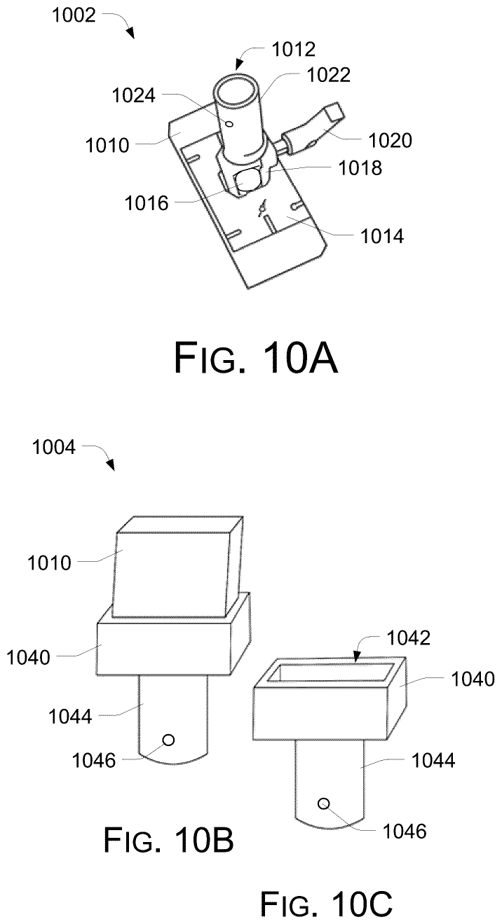

Referring to FIGS. 9A-9C and 10A-10C, in some embodiments, a set 200 can include one or more additional components and/or tools. Some example components and tools are shown in the figures. For example, the set 200 can include a durable carrying case 900, a scraper tool 902, a razor blade tool 904, a first type of wax tool 1002, a second type of wax tool 1004, and the like. One or more of the additional components and tools, such as the scraper tool 902, the razor blade tool 904, or the wax tools 1002 and 1004 can include a receiver (such as the receiver 222 or 224) arranged to couple to the handle 206. For instance, as shown at FIG. 9B, the scraper tool 902 can comprise a scraping component 912 coupled to a receiver 922. The receiver 922 can include the features described above with respect to receivers 222 and 224 for coupling to a handle 206, and/or other features.

Referring to FIG. 10A, in some embodiments, a wax tool 1002 can be similar to the brick tool 202 discussed previously-with a wax block 1010 instead of the abrasive stone 210. In various examples, a wax block 1010 (or like natural or synthetic material) is coupled to a receiver 1012 for attachment to the handle 206. The wax block 1010 provides a waxy coating to coat the concrete (and other materials) and is sized to accommodate multiple uses.

The wax block 1010 can be mounted to the receiver 1012 via a wax mount 1014 as shown. The wax mount 1014 comprises a bracket or a like component that can be coupled to the wax block 1010. For example, the wax mount 1014 can include holes or slots for mounting the wax mount 1014 to the wax block 1010, with removable fasteners, for instance. The wax mount 1014 also includes mount components for coupling the receiver 1012 to the wax mount 1014.

In one example, as shown at FIG. 10A, the mount component comprises a ball mount 1016. The ball mount 1016 can be fixed to the wax mount 1014. In the example, the receiver jaws 1018 of the receiver 1012 can clamp over the ball mount 1016, securing the receiver 1012 to the wax mount 1014. A jaw tensioner 1020 is used to tighten the receiver jaws 1018 onto the ball mount 1016 at the desired position and angle. For example, the jaw tensioner 1020 can be threaded into at least one of the receiver jaws 1018, to tighten or loosen the receiver jaws 1018 on the ball mount 1016. This arrangement allows for infinite adjustment of the position and angle of the receiver 1012 (and thus the handle 206) on the wax mount 1014. The handle 206 is inserted into the barrel 1022 of the receiver 1012, and the quick release button 262 of the handle 206 engages the quick release hole 1024 of the barrel 1022. The interior surface of the barrel 1022 may be smooth or featured (such as threaded, for example).

Alternately, the receiver 1012 can be coupled to the wax mount 1014 via angle adjustment teeth on the wax mount 1014 that engage angle adjustment teeth on the receiver 1012, as described above with reference to the brick tool 202 and FIGS. 4A and 4B.

Referring to FIGS. 10B and 10C, in other embodiments, a wax tool 1004 can have a different configuration. As shown, the wax block 1010 can be fitted to a mount 1040, where a portion of the wax block 1010 may be inserted into a cavity 1042 of the mount 1040. FIG. 10B shows the wax block 1010 fitted to the mount 1040, and FIG. 10C shows the mount 1040 without the wax block 1010. The cavity 1042 can have a close dimension to the wax block 1010 so as to grip the wax block 1010.

The mount 1040 is coupled to (or integral with) a receiver 1044. The handle 206 is inserted into the receiver 1044, and the quick release button 262 of the handle 206 engages the quick release hole 1046 of the receiver 1044. The interior surface of the receiver 1044 may be smooth or featured (such as threaded, for example). In some cases, an angle or position adjustment can also be used with the receiver 1044 with respect to the mount 1040.

In other embodiments, other additional components may also be included in the set 200, such as a multi-tool quick adapter, marking implements, measuring tools, and so forth.

Aspects of the present disclosure have been described with the intent to be illustrative rather than restrictive. Alternative aspects will become apparent to those skilled in the art that do not depart from its scope. A skilled artisan may develop alternative means of implementing the aforementioned features without departing from the scope of the present disclosure. Further, while described in the context of skateboarding, the tools (e.g., 202, 204, 206, and 1002) and the tool set 200 can be used for other purposes than described herein (e.g., masonry, construction, etc.) and remain within the scope of the disclosure.

FIGS. 1A-10C are not intended to be restrictive, and the components may have additional or alternate components, dimensions, and so forth, while performing the functions (or equivalent functions) described herein, and without departing from the scope of the disclosure. Although various implementations and examples are discussed herein, further implementations and examples may be possible by combining the features and elements of individual implementations and examples.

It will be understood that certain features and sub-combinations are of utility and may be employed without reference to other features and sub-combinations and are contemplated within the scope of the claims. Not all steps listed or disclosed need be carried out in the specific order described.

### Conclusion

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims.

What is claimed is:

1. An interchangeable tool system, comprising:
an adjustable handle;
a broom tool configured to be releasably coupled to a first end of the handle; and
a brick tool configured to be releasably coupled to the first end of the handle.

2. The interchangeable tool system of claim 1, further comprising a handle extension configured to be releasably coupled to a second end of the handle.

3. The interchangeable tool system of claim 1, further comprising a wax tool configured to be releasably coupled to the first end of the handle.

4. The interchangeable tool system of claim 1, further comprising a scraper configured to be releasably coupled to the first end of the handle.

5. The interchangeable tool system of claim 1, the broom tool further comprising a receiver configured to be coupled to a brush of the broom tool, the receiver having a first end arranged to be inserted into the brush and a second end arranged to receive the first end of the handle and including a quick release hole configured to engage with a quick release button at the first end of the handle.

6. The interchangeable tool system of claim 5, wherein the handle includes a threaded portion at the first end and wherein the receiver includes a barrel with a threaded interior surface.

7. The interchangeable tool system of claim 1, the brick tool further comprising a receiver configured to be coupled to a brick mount of the brick tool, the receiver having a first end arranged to be adjustably mounted to the brick mount and a second end arranged to receive the first end of the handle and including a quick release hole configured to engage with a quick release button at the first end of the handle.

8. The interchangeable tool system of claim 7, wherein the handle includes a threaded portion at the first end and wherein the receiver includes a barrel with a threaded interior surface.

9. The interchangeable tool system of claim 7, wherein the receiver includes a toothed angle adjustment component arranged to mate with a toothed component at the brick mount.

10. An interchangeable tool system, comprising:
an adjustable length handle, comprised of a plurality of interconnecting handle segments;
a broom tool configured to be releasably and interchangeably coupled to a first end of the handle, the broom tool comprising a brush component and a first receiver component arranged to receive the first end of the handle; and
a brick tool configured to be releasably and interchangeably coupled to the first end of the handle, the brick tool comprising an abrasive stone component, a second receiver component arranged to receive the first end of the handle, and a mount component arranged to couple the second receiver component to the abrasive stone component.

11. The interchangeable tool system of claim 10, further comprising one or more handle extension segments.

12. The interchangeable tool system of claim 10, wherein the first receiver component and the second receiver component each include a barrel with a quick release hole disposed therethrough, the quick release hole arranged to engage a quick release button on the first end of the handle.

13. The interchangeable tool system of claim 10, wherein the brick tool includes a ball mount coupled to the mount component arranged to determine and to adjust a position and an angle of the second receiver with respect to the abrasive stone component.

14. The interchangeable tool system of claim 10, wherein the first end of the handle includes a threaded twist coupling.

15. The interchangeable tool system of claim 14, wherein an interior surface of a barrel of the first receiver component or the second receiver component includes thread-like features.

16. The interchangeable tool system of claim 10, further comprising a wax tool configured to be releasably and interchangeably coupled to the first end of the handle, the wax tool comprising a wax block component, a third receiver component arranged to receive the first end of the handle, and a wax mount component arranged to couple the third receiver component to the wax block component.

17. An interchangeable tool system, comprising:
an adjustable length handle, comprised of a plurality of interconnecting handle segments, and having an insertion end with a quick coupling feature;
a broom tool configured to be releasably and interchangeably coupled to the insertion end of the handle, the broom tool comprising a brush component and a first receiver arranged to receive the insertion end of the handle and including a first mating feature configured to engage with the quick coupling feature; and
a brick tool configured to be releasably and interchangeably coupled to the insertion end of the handle, the brick tool comprising an abrasive stone component, a second receiver arranged to receive the insertion end of the handle and including a second mating feature configured to engage with the quick coupling feature, and a mount component arranged to couple the second receiver to the abrasive stone component.

18. The interchangeable tool system of claim 17, wherein the quick coupling feature comprises a biased quick release button.

19. The interchangeable tool system of claim 18, wherein at least one of the first and second mating features comprises a quick release hole configured to receive the quick release button.

20. The interchangeable tool system of claim 17, wherein the brick tool includes a ball mount arranged to determine and to adjust a position and an angle of the second receiver with respect to the abrasive stone component.
